(19) United States
(12) Patent Application Publication
(10) Pub. No.: US 2012/0114265 A1
(43) Pub. Date: May 10, 2012

(54) Image Contrast Enhancement

(75) Inventors: Jonathan Yen, San Jose, CA (US); William C. Kress, Mission Viejo, CA (US); Bradley S. Winslow, Salem, NH (US)

(73) Assignees: Toshiba Tec Kabushiki Kaisha, Shinagawa-ku (JP); Kabushiki Kaisha Toshiba, Minato-ku (JP)

(21) Appl. No.: 12/940,934

(22) Filed: Nov. 5, 2010

(51) Int. Cl. G06K 9/40

(52) U.S. Cl. 382/274

(57) ABSTRACT

Systems and methods for image contrast enhancement are disclosed. A tone reproduction curve function is generated for a plurality of pixel values, each including a brightness value, based on a contrast adjustment value, the brightness value of each of the pixels and a power-law function, the tone reproduction curve taking the form of an S-shaped curve. The S-shaped curve includes a bulging curve portion corresponding to an area wherein a brightness of pixels having values representative of relative brightness is increased, a sagging curve portion corresponding to an area wherein a brightness of pixels having values representative of relative darkness is decreased, and an inflection point serving as a demarcation between the bulging area and the sagging area of the tone reproduction curve. The exponent of the power-law function is generated as a quadratic polynomial function f(x) in a range 0≦f(x)≦1, wherein x is defined as a curvature factor. The tone reproduction curve is then applied to the image data to generate contrast enhanced image data. The enhanced image data is then output to an associated image rendering device.

### RELATED APPLICATION INFORMATION

This application claims priority from U.S. Provisional Patent Application No. 61/258,698, filed on Nov. 6, 2009, titled “Image Contrast Enhancement With S-Curve” which is incorporated herein by reference.

### BACKGROUND

1. Field

Embodiments described herein relate generally to image contrast enhancement.

2. Description of the Related Art

Images that are visible to the human eye have a wide range of differences between lighter portions and darker portions. Constraints in either image capture or image generation technology or constraints in image rendering technology typically result in images that are relatively constrained as to a range between lighter and darker regions. Viewing and rendering of images that are constrained to such a range can be improved by adjusting the image properties within the available dynamic range.

An image captured by digital cameras, digital recorders or scanners is typically stored in an electronic form. These images in electronic form are often stored as a series of image portions, referred to as picture elements or pixels. Numerically encoded pixel values can be manipulated mathematically. Mathematical adjustment of image contrast is one method available to improve image fidelity.

### DESCRIPTION OF THE DRAWINGS

FIG. 1 is an overall diagram of a system or a method for image contrast enhancement.

FIG. 2 is a block diagram of device hardware for use in a system or a method for image contrast enhancement.

FIG. 3 is a functional diagram of a device for use in a system or a method for image contrast enhancement.

FIG. 4 is a block diagram of controller hardware for use in a system or a method for image contrast enhancement;

FIG. 5 is a functional diagram of a controller for use in a system or a method for image contrast enhancement.

FIG. 6 is a diagram of a workstation for use in a system or a method for image contrast enhancement.

FIG. 7 is a block diagram of a system for image contrast enhancement.

FIG. 8 is a flowchart of a method for image contrast enhancement.

FIG. 9 is a flowchart of a method for image contrast enhancement.

FIG. 10 is an example of an S-shaped tone reproduction curve for use in a system or a method for image contrast enhancement.

FIG. 11 is an example of an input image, an output image, and a corresponding tone reproduction curve for use in a system or a method for image contrast enhancement.

FIG. 12 is an example of an input image before contrast enhancement and an output image after contrast enhancement for use in a system or a method for image contrast enhancement.

FIG. 13 is an example of a sagging portion of the S-shaped tone reproduction curve for use in a system or a method for image contrast enhancement.

FIG. 14 is a reversed sagging portion of the S-shaped tone reproduction curve of FIG. 13.

FIG. 15 is a graph of one minus the reversed sagging portion of the S-shaped tone reproduction curve of FIG. 14.

FIG. 16 is an example of a bulging portion of the S-shaped tone reproduction curve for use in a system or a method for image contrast enhancement.

FIG. 17 is an example of an S-shaped tone reproduction curve for use in a system or a method for image contrast enhancement.

FIG. 18 is an example of an S-shaped tone reproduction curve for 8-bit code values for use in a system or a method for image contrast enhancement.

FIG. 19 is an example of curvature factor controlling contrast via S-shaped curves for use in a system or a method for image contrast enhancement.

FIG. 20 is an illustration of corresponding contrast measurement of FIG. 19 and respective images for use in a system or a method for image contrast enhancement.

FIG. 21 is an example of contrast measurement against curvature factor for use in a system or a method for image contrast enhancement.

FIG. 22 is an example of the variation of inflection points with respect to curvature factors for use in a system or a method for image contrast enhancement.

FIG. 23 shows the corresponding contrast measurements of the inflection points of FIG. 22 via corresponding images for use in a system or a method for image contrast enhancement.

FIG. 24 is an example of contrast measurement against inflection points for use in a system or a method for image contrast enhancement.

FIG. 25 is an RGB histogram corresponding to the input image associated with

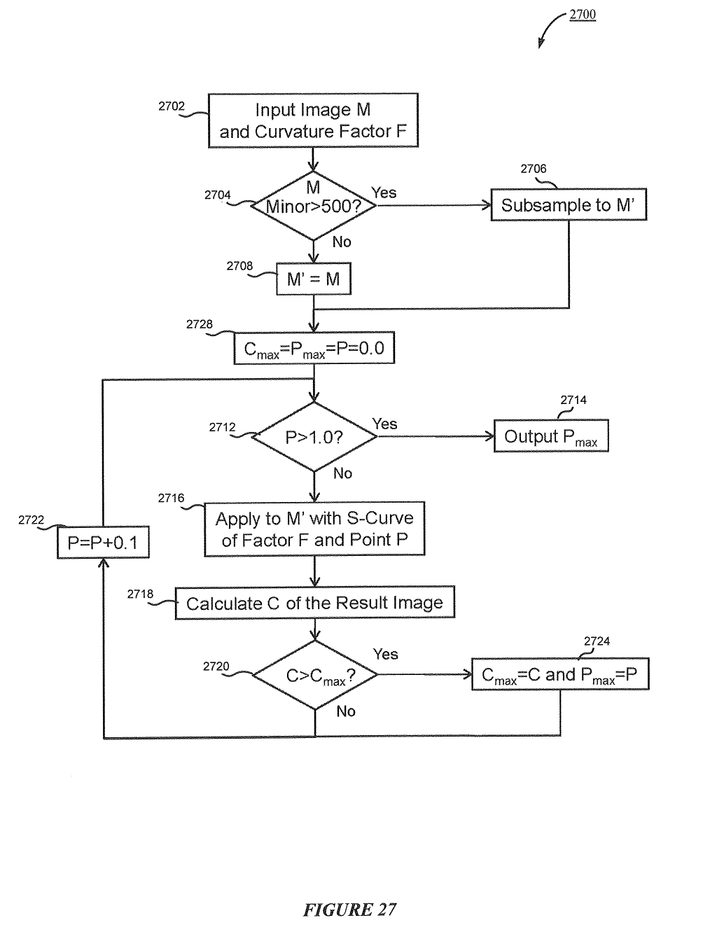

FIG. 24 for use in a system or a method for image contrast enhancement.

FIG. 26 shows image scaling methods for use in a system or a method for image contrast enhancement.

FIG. 27 is a flowchart showing an example method for inflection point location for use in a system or a method for image contrast enhancement.

FIG. 28 is a generalized formulation of the S-shaped tone reproduction curve used in a system or a method for image contrast enhancement.

### DETAILED DESCRIPTION

Image contrast enhancement systems and methods are disclosed. According to certain embodiments, a tone reproduction curve function is generated for a plurality of pixel values, each including a brightness value, based on a contrast adjustment value, the brightness value of each of the pixels and a power-law function, the tone reproduction curve taking the form of an S-shaped curve. The S-shaped curve includes a bulging curve portion corresponding to an area wherein a brightness of pixels having values representative of relative brightness is increased, a sagging curve portion corresponding to an area wherein a brightness of pixels having values representative of relative darkness is decreased, and an inflection point serving as a demarcation between the bulging area and the sagging area of the tone reproduction curve. According to certain embodiments, the exponent of the power-law function is generated as a quadratic polynomial function f(x) in a range 0≦f(x)≦1, wherein x is defined as a curvature factor. The tone reproduction curve is then applied to the image data to generate contrast enhanced image data. The enhanced image data is then output to an associated image rendering device.

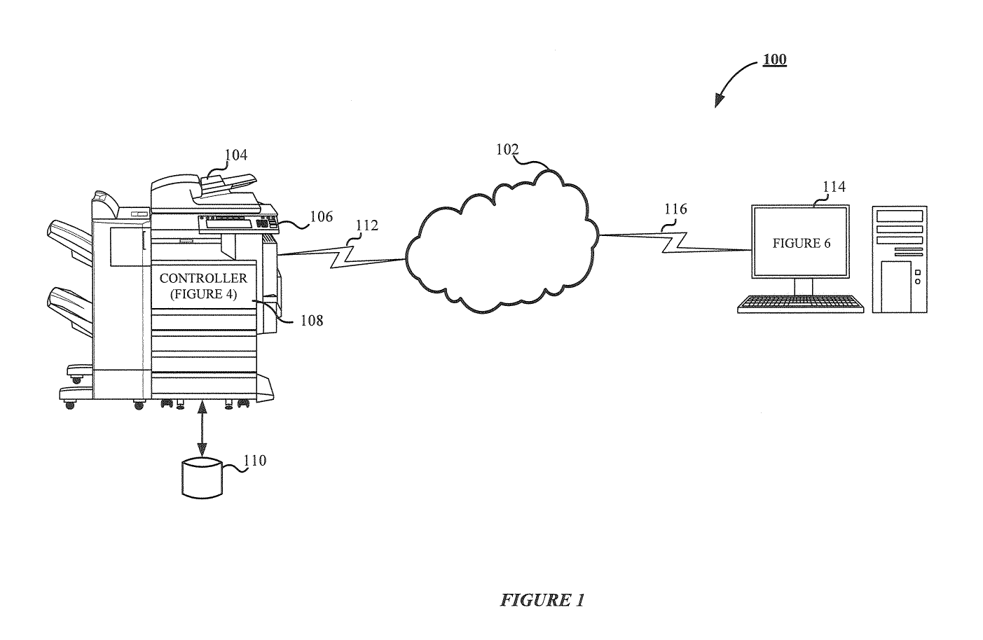

Referring now to FIG. 1, an overall diagram of an example system 100 for implementation of image contrast enhancement is shown. The system 100 may be implemented in a distributed computing environment such as computer network 102. The computer network 102 enables the exchange of data between two or more electronic devices. The computer network 102 may be a virtual local area network, a wide area network, a personal area network, a local area network, the Internet, an intranet, or any combination of these. The computer network 102 may have physical layers and transport layers such as Token-Ring, 802.11(x), Ethernet, or other wireless or wire-based data communication mechanisms.

The system 100 also includes a document processing device 104, shown in FIG. 1 as a multifunction peripheral device, designed for a variety of document processing operations such as facsimile, scanning, copying, printing, electronic mail, document management and document storage. The Toshiba e-Studio Series Controller is one example of such a device. The document processing device 104 provides remote document processing services to external or network devices. The document processing device 104 may also include an audio reproduction component (not shown) such as a speaker, capable of emitting sounds.

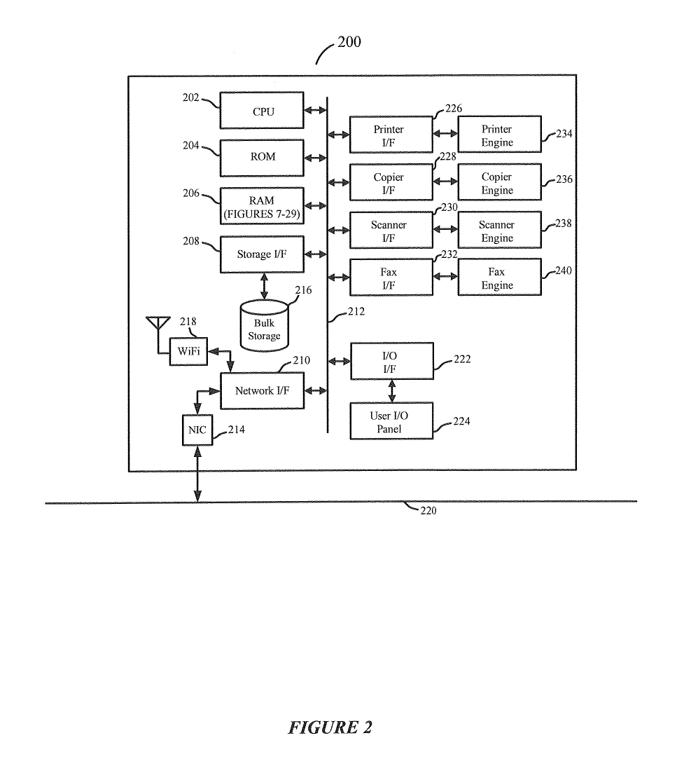

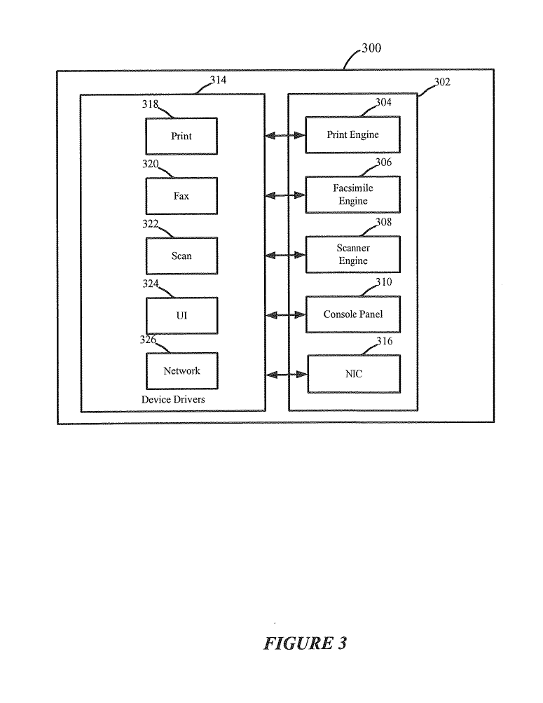

The document processing device 104 is suitably equipped to receive a plurality of portable storage media including Firewire drives, USB drives, SD, MMC, XD, Compact Flash, and Memory Stick. The document processing device 104 includes an associated user interface 106, such as a touchscreen, LCD display, touch-panel, or alpha-numeric keypad through which an associated user is able to interact directly with the document processing device 104. The user interface 106 is used to communicate information to and receive selections from a user. The user interface 106 includes various components, used to present data to a user. The user interface 106 typically includes a display for displaying graphical elements, text data or images to a user. The user interface may also receive input from the associated user, and communicate the same to a backend component, such as controller 108. The document processing device 104 coupled to the computer network 102 via a communications link 112. Communications links include WiMax, 802.11a, 802.11b, 802.11g, 802.11(x), Bluetooth, the public switched telephone network, a proprietary communications network, infrared, optical, or any other wired or wireless data transmission communications. The document processing device 104 will be better understood in conjunction with the block diagrams illustrated in FIGS. 2 and 3, described below.

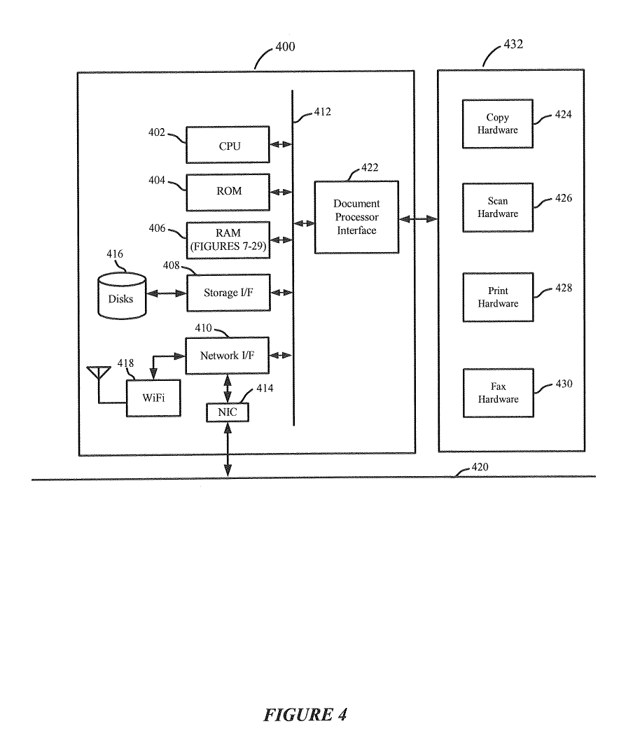

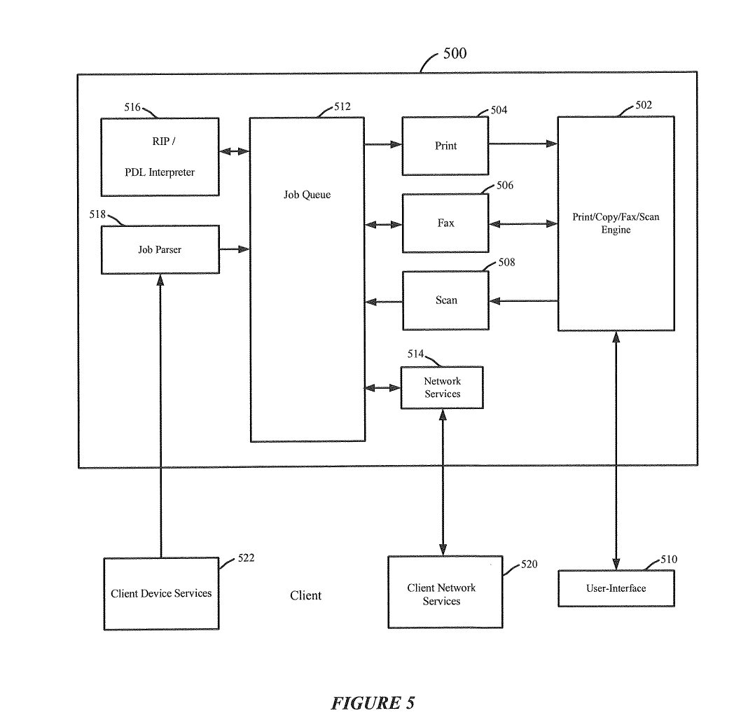

The document processing device 104 includes a controller 108 that enables many of the operations of the document processing device 104. The controller 108 may be embodied in hardware, software, or any combination of the two. The controller 108 is configured to control the operations of the associated document processing device 104, facilitate the display of images via the user interface 106, and direct the manipulation of electronic image data. The controller 108 is used to refer to any number of components associated with the document processing device 104. The functions described as performed by the controller 108 may be performed by any general purpose computing system. The controller 108 will better be understood in conjunction with FIGS. 4 and 5, described below.

The document processing device 104 is connected to a data storage device 110. The data storage device 110 may be any mass storage device such as magnetic storage drives, a hard disk drive, optical storage devices or flash memory devices. The data storage device 110 can store scanned image data, color measurement data and color calibration data. While FIG. 1 shows the data storage device 110 as a separate component of the system 100, the data storage device 110 may be implemented as an internal storage component of the document processing device 104 or a component of the controller 108 such as an internal hard disk drive. The data storage device 110 is capable of storing various types of data including document processing instructions, usage data, user interface data, job control data, controller status data, component execution data, images, advertisements, user information, location information, output templates, mapping data, multimedia data files and fonts.

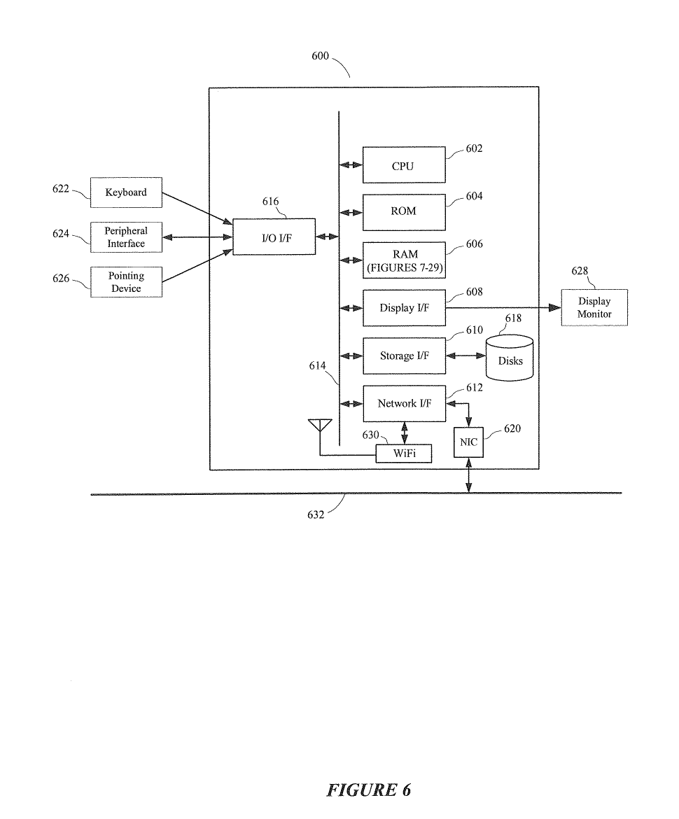

A user device 114 is also shown in FIG. 1 as a computer workstation connected by means of a communications link 116 with the computer network 102. The user device 114 is shown as a computer workstation for illustration purposes only. As user device 114 may take any number of forms including a laptop computer, a workstation computer, a personal data assistant, a web-enabled cellular telephone, a smart phone, a proprietary network device, or other web-enabled electronic device. The communications link 116 may be any suitable channel of data communications such as a wired or wireless connection including Bluetooth, WiMax, 802.11a, 802.11b, 802.11g, 802.11(x), a proprietary communications network, infrared, optical, the public switched telephone network, or any wireless or wired communication. The user device 114 facilitates the image contrast enhancement and communication with the document processing device 104. The user device 114 may also include an audio reproduction component (not shown) such as a speaker, or the like, capable of sounds. The user device 114 will better be understood in conjunction with the diagram shown in FIG. 6, described below.

Turning now to FIG. 2, suitable example of a document processing device 104, shown in FIG. 1, is shown as device 200. The device 200 includes processor 202, such as a central processor unit or multiple processors working in concert with one another. The device 200 also includes non-volatile or read only memory 204 which is used for static or fixed data or instructions, such as BIOS functions, system functions, system configuration data, and other routines or data used for operation of the device 200.

Also included in the device 200 is random access memory 206 such as dynamic random access memory, static random access memory, or any other addressable memory system. Random access memory 206 provides a storage area for data instructions associated with applications and data handling by the processor 202. A storage interface 208 provides a mechanism for volatile, bulk or long term storage of data associated with the device 200. The storage interface 208 uses bulk storage, such as any suitable addressable or serial storage, such as a disk, or optical and tape drives as shown as 216.

A network interface subsystem 210 routes input and output from an associated network allowing the device 200 to communicate to other devices. The network interface subsystem 210 interfaces with one or more connections with external devices to the device 200. By way of example, one network interface card 214 for data communication with fixed or wired networks, such as Ethernet, token ring, and the like, and a wireless interface 218, for wireless communication via means such as WiFi, WiMax, wireless modem, cellular network, or any suitable wireless communication system. In the illustration, the network interface card 214 is interconnected for data interchange via a physical network 220, typically a local area network, wide area network, or a combination of the two.

A bus 212 enables data communication between the processor 202, read only memory 204, random access memory 206, storage interface 208 and the network subsystem 210. Executable instructions on the device 200 facilitate communication with a plurality of external devices, such as workstations, document processing devices, other servers, or the like. While in operation a typical device operates autonomously. However, direct control by a local user is sometimes desirable. Such control is accomplished via an optional input/output interface 222 to a user input/output panel 224.

The bus 212 is also connected to one or more document processing engines. The printer interface 226, copier interface 228, scanner interface 230, and facsimile interface 232 are examples of document processing engines. These engines facilitate communication with printer engine 234, copier engine 236, scanner engine 238, and facsimile engine 240, respectively. The device 200 is designed to accomplish one or more document processing functions. Systems capable of more than one document processing operation are commonly referred to as multifunction peripherals or multifunction devices.

Turning now to FIG. 3, the document processing device 300, previously depicted in FIG. 1 as the document processing device 104, is shown. FIG. 3 shows the functionality of the hardware of FIG. 2 in connection with software and operating system functionality. The document processing device 300 includes an engine 302 which facilitates one or more document processing operations.

The document processing engine 302 also includes a print engine 304, facsimile engine 306, scanner engine 308 and console panel 310. The print engine 304 allows for output of physical documents representative of an electronic document. The facsimile engine 306 communicates to or from external facsimile devices via a device, such as a fax modem. The scanner engine 308 receives hard copy documents and corresponding image data. A user interface, such as the console panel 310, allows a user to input of instructions and displays information to a user. The scanner engine 308 is used to accept the input of tangible documents and to convert them into electronic form as bitmapped, vector or page description language format. The scanner engine 308 may also perform optical character recognition.

Tangible document scanning also facilitates facsimile output.

As shown in FIG. 3, the document processing engine also includes an interface 316 with a network via driver 326, including a network interface card. The document processing engine 302 can interface with the network via various types of connections including wired, wireless or optical data communication.

The document processing engine 302 communicates with one or more device drivers 314. These device drivers 314 enable data interchange between the document processing engine 302 and one or more physical devices used to accomplish document processing operations. These document processing operations include printing via driver 318, facsimile communication via driver 320, scanning via driver 322 and a user interface functions via driver 324. These various devices may be integrated with one or more corresponding engines associated with the document processing engine 302. The document processing engine 302, using the various elements described, is capable of any set or subset of document processing operations. As such, these types of document processors are often described as multi-function peripherals.

Turning now to FIG. 4, a representative architecture of the controller 400, shown in FIG. 1 as the controller 108, is shown. The controller 400 may be any general computing device capable of the methodologies described herein. The controller 400 includes a processor 402, such as a central processor unit or multiple processors working in concert with one another. Non-volatile or read only memory 404 is used for static or fixed data or instructions, such as BIOS functions, system functions, system configuration data, and other routines or data used for operation of the controller 400.

The controller 400 also includes random access memory 406, such as dynamic random access memory, static random access memory or other addressable and writable memory system. Random access memory provides a storage area for data instructions associated with applications and data handling accomplished by processor 402. A storage interface 408 provides a mechanism for non-volatile, bulk or long term storage of data associated with the controller 400. The storage interface 408 uses disks 416 which may be disk-based, optical or tape drives for bulk storage.

A network interface subsystem 410 routes input and output from an associated network allowing the controller 400 to communicate with other devices. The network interface subsystem 410 interfaces with external devices using one or more connections. One network interface card 414 is shown, though more may be employed. The network interface card 414 may be used for data communication with fixed or wired networks, such as Ethernet, Token-Ring, and a wireless interface 418, for wireless communication via means such as WiFi, WiMax, wireless modem, cellular network or other wireless communication system. The network interface subsystem may use any type of physical or non-physical data transfer layer or protocol layer. The network interface 414 is connected to a physical network 420, such as a local area network, wide area network or a combination of both.

A bus 412 is used for data communication between the processor 402, read only memory 404, random access memory 406, storage interface 408 and the network interface subsystem 410. The document processor interface 422 also uses the buss 412 for data communication. The document processor interface 422 communicates with hardware 432 in order to perform one or more document processing operations. The types of operations that may be performed include copying using the copy hardware 424, scanning using the scan hardware 426, printing using the print hardware 428, and facsimile communication using the facsimile hardware 430. The controller 400 controls each of the document processing operations.

The functionality described herein is implemented on a document processing device 104 including the controller 400 of FIG. 4, (shown in FIG. 1 as the controller 108) as an intelligent subsystem associated with a document processing device.

FIG. 5 shows the functionality of the hardware of FIG. 4 in connection with software and operating system functionality. FIG. 5 shows the controller function 500. The controller function 500 includes a document processing engine 502. The engine 502 enables printing operations, copy operations, facsimile operations and scanning operations. These types of operations are typical of multi-function devices. However, the subject controller need not have all of the capabilities described. Controllers may implement one or more of the document processing operations described above.

The engine 502 includes a user interface panel 510 for accessing the various functions of the engine 502. Access may be local or remotely via a remote thin or thick client. The engine 502 may also communicate with the print function 504, facsimile function 506, and scan function 508. These functions enable printing, facsimile transmission and reception, and document scanning for use in securing document images for copying or generating electronic versions.

A job queue 512 stores a series of jobs for execution by the print function 504, facsimile function 506, and scan function 508. Various image forms, such as bitmap, page description language or vector format may be relayed to the job queue 512 from the scan function 508 for handling.

The job queue 512 may also communicate using network services 514. Information such as, job control, status data, or electronic document data may be exchanged between the job queue 512 and the network services 514. Network-based access to the controller function 500 using client network services 520 may also be provided. The network-based access may be accomplished using a hypertext transfer protocol, file transfer protocol, uniform data diagram protocol, or any other network exchange mechanism. The network services 514 also enable data interchange with client network services 520 for communication via FTP, electronic mail or TELNET. The controller function 500 enables output and receipt of electronic documents and user information using the network services 514.

The job queue 512 may also communicate with an image processor 516. The image processor 516 may be a raster image processer, page description language interpreter or any suitable mechanism for conversion of an electronic document into a format for use in device functions like print 504, facsimile 506 or scan 508 functions.

The job queue 512 may also communicate with a parser 518 for use in receiving print job language files from an external device, such as client device services 522. The client device services 522 may include printing, facsimile transmission, or other input of an electronic document for handling by the controller function 500. The parser 518 interprets a received electronic document and relays it to the job queue 512 for handling.

Turning now to FIG. 6, a hardware diagram of a workstation 600 is shown. This workstation was previously identified as user device 114 in FIG. 1. The workstation 600 includes a processor 602 which may communicate with read only memory 604, non-volatile read only memory, volatile read only memory or a combination of both, random access memory 606, display interface 608, storage interface 610, and network interface 612. The bus 614 communicates and interfaces with the various modules. The read only memory 604 may include firmware, such as static data or fixed instructions, BIOS, system functions, configuration data, and other routines used during the operation of the workstation 600 and CPU 602. The random access memory 606 also provides a storage area for data and instructions associated with applications and data handling by the processor 602.

The display interface 608 receives data or instructions from other components on the bus 614 which is used to a display to facilitate a user interface. The display interface 608 provides output to a display terminal 628, such as a monitor, LCD or plasma display device.

The storage interface 610 provides non-volatile, bulk or long term storage of data or instructions in the workstation 600. The storage interface 610 may use storage 618 which may take the form of a disk, tape, CD, DVD, or other reasonably high capacity addressable or serial storage medium.

The network interface 612 communicates to at least one other network interface, shown as network interface 620, such as a network interface card, and wireless network interface 630, such as a WiFi wireless network card. A network interface 612 may communicate using both physical and protocol layers. It may also use any wired or wireless system, such as Ethernet, Token-Ring, any other wide area or local area network communication system, WiFi or WiMax. The network interface 620 is interconnected for data interchange using a physical network 632, such as a local area network, wide area network, or a combination of both.

An input/output interface 616 uses the bus 614 connected to an input device 622, such as a keyboard or a mouse. The input/output interface 616 also provides data output to a peripheral interface 624, such as a USB, universal serial bus output, SCSI or Firewire (IEEE 1394) output. The input/output interface 616 may also communicate with a pointing device interface 626 used to connect to devices, such as a mouse, light pen or touch screen.

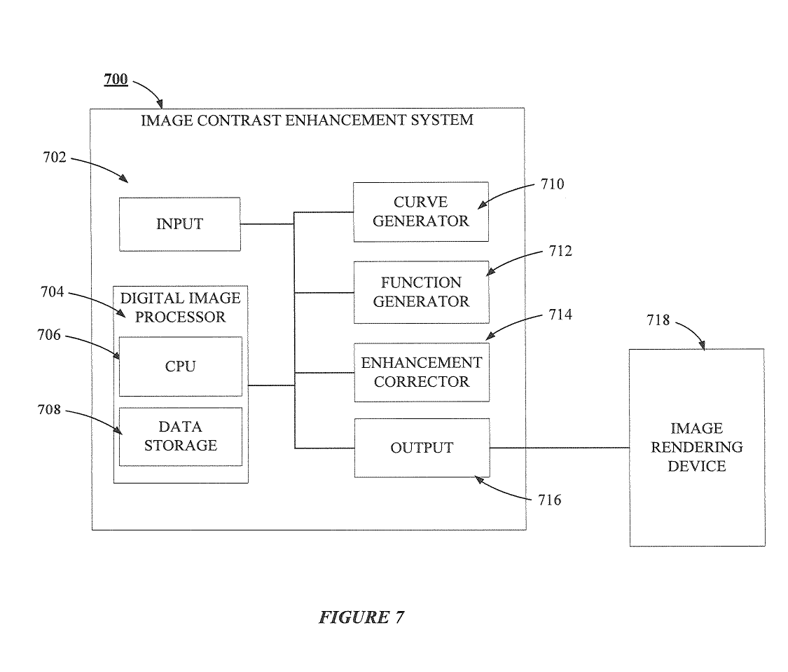

FIG. 7 is a block diagram of an image contrast enhancement system 700. The image contrast enhancement system may be implemented in the controller 108 or user device 114, as described with reference to FIGS. 1-6 above. The contrast enhancement system 700 includes an input 702 for receipt of image data into a digital image processor 704. The digital image processor 704 may include at least one CPU 706 and associated data storage 708. The image data includes digital pixel values, each including a brightness value.

The system 700 further employs a curve generator 710 that generates a tone reproduction curve function corresponding to a relationship between a contrast adjustment value relative to the brightness value of each of the pixels and a power-law function. The tone reproduction curve includes an S-shaped curve functional relationship that has a bulging curve portion, a sagging curve portion, and an inflection point at a demarcation between the bulging area and the sagging area of the tone reproduction curve. Thus, the bulging curve portion corresponds to an area where the brightness of pixels having values representative of relative brightness is increased, and the sagging curve portion corresponds to an area where the brightness of pixels having values representative of relative darkness is decreased.

The contrast enhancement system 700 also includes a function generator 712, an enhancement corrector 714, and an output 716. The function generator 712 is used to generate the exponent of the power-law function as a quadratic polynomial function f(x) in a range 0≦f(x)≦1, where x is defined as a curvature factor. The enhancement corrector 714 applies the tone reproduction curve to the image data so as to generate contrast enhanced image data, and the output 716 may output the contrast enhanced image data to an associated image rendering device 718.

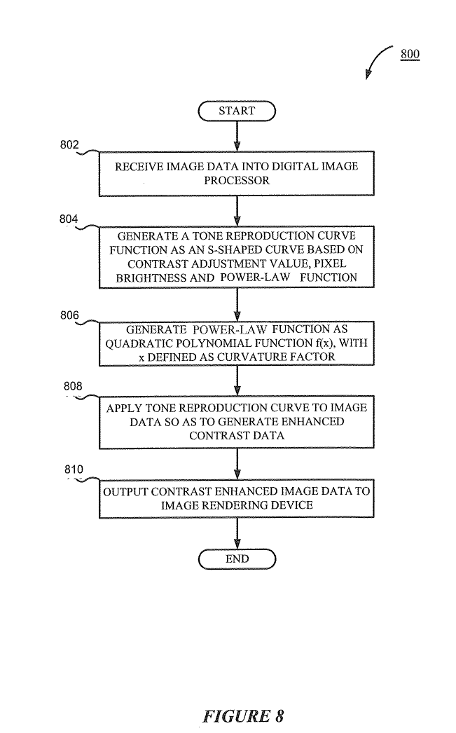

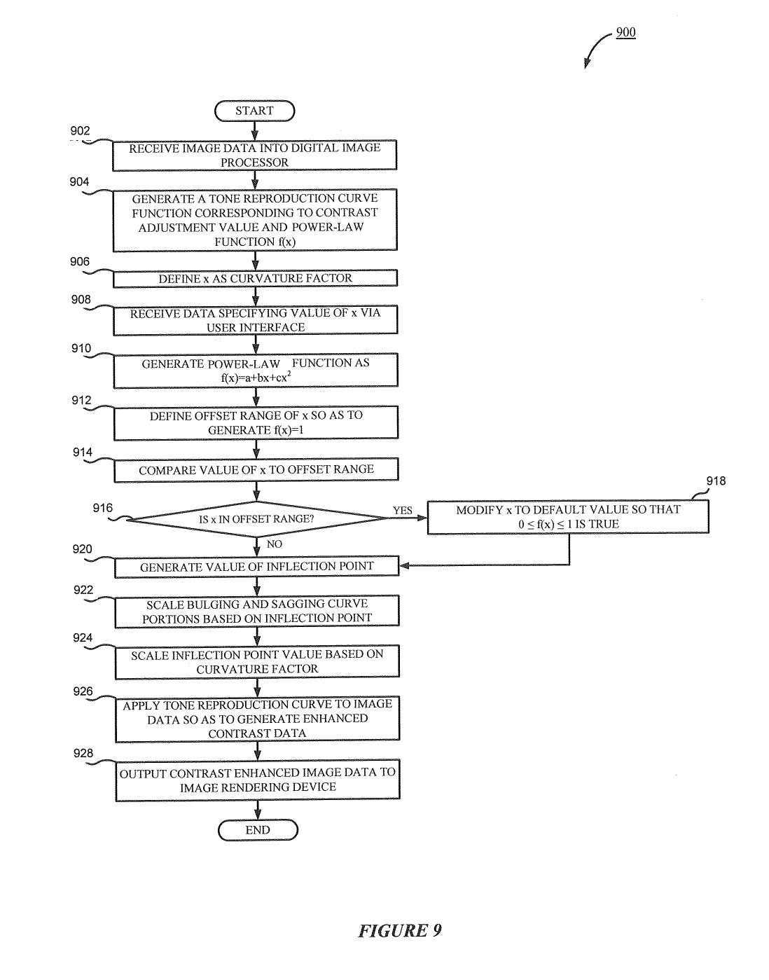

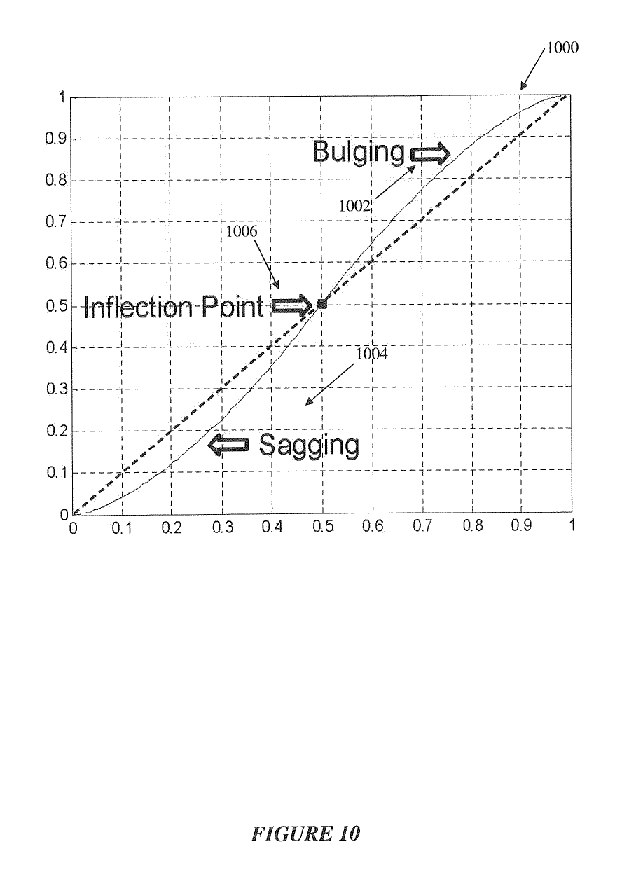

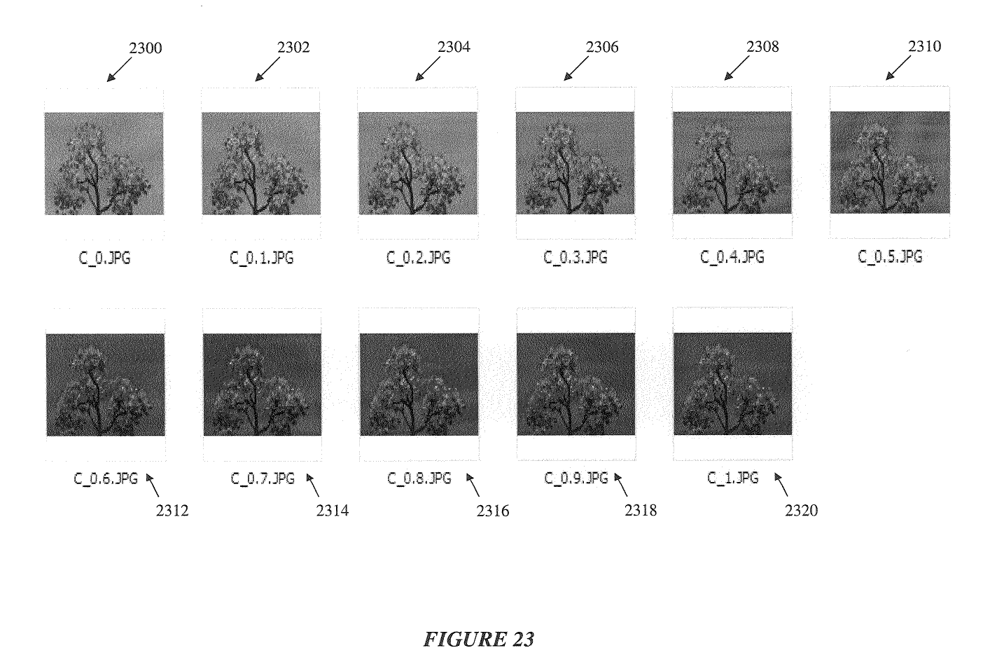

The system 100 and components described above with respect to FIGS. 1-7, will be better understood in conjunction with the methodologies described hereinafter with respect to FIG. 8 and FIG. 9, as well as the example illustrations of FIGS. 10-28. Turning now to FIG. 8, there is shown a flowchart 800 illustrating an image contrast enhancement method in accordance with one embodiment of the subject application. Beginning at 802, image data is received into a digital image processor that has one or more CPUs and associated data storage. The image data includes digital pixel values. Each of these pixel values includes a brightness value.

At 804, a tone reproduction curve function is generated which corresponds to the relationship between a contrast adjustment value relative to the brightness value of each of the pixels and a power-law function. The tone reproduction curve generated at 804 may include an S-shaped curve functional relationship having a bulging curve portion, a sagging curve portion, and an inflection point. The bulging curve portion corresponds to an area wherein the brightness values of pixels are increased, while the sagging curve portion corresponds to an area wherein the brightness values of pixels are decreased. An inflection point defines the demarcation between the bulging area and the sagging area of the tone reproduction curve.

The exponent of the power-law function is then generated, at 806, as a quadratic polynomial function f(x) in a range 0≦f(x)≦1, wherein x is defined as a curvature factor. At 808, the tone reproduction curve is applied to the image data so as to generate contrast enhanced image data. The contrast enhanced image data is then output, at 810, to an associated image rendering device.

Referring now to FIG. 9, a flowchart 900 of a method for image contrast enhancement is shown. The methodology of FIG. 9 begins at 902, when image data is received by a digital image processor such as the controller 108 or other component associated with the document processing device 104 or the user device 114. The digital image processor includes at least one CPU and associated data storage such as system memory or the data storage device 110. The image data received includes a plurality of digital pixel values, each including a brightness value.

A tone reproduction curve function is then generated at 904 corresponding to a relationship between a contrast adjustment value relative to the brightness value of each of the pixels and a power-law function with exponent (f(x)). Preferably, the exponent f(x) is defined as f(x)=a+bx+cx̂2. The tone reproduction curve includes an S-shaped curve functional relationship that has a bulging curve portion, a sagging curve portion and an inflection point. The bulging curve portion corresponds to an area where the brightness values of pixels are increased. The sagging curve portion corresponds to an area where the brightness values of pixels are decreased. An inflection point is the demarcation between the bulging area and the sagging area of the tone reproduction curve.

At 906, the x variable of the exponent (f(x)), is defined as a curvature factor such that 0≧x≧root of f(x)−1. Data is then received at 908 for a value of x from a user at the user interface 106, or other suitable input device such as a keyboard or mouse associated with the user device 114. The quadratic polynomial function f(x) is then generated at 910 in a range 0≦f(x)≦1, using the controller 108, the user device 114, or other processing device.

A preselected offset range is then defined, at 912, so as to generate the quadratic polynomial function f(x) so as to correspond to a value of 1. At 914, the value of x is compared relative to the preselected offset range. At 916, a determination is made whether the value of x falls within the preselected offset range. If so, flow proceeds to 918, whereupon x is modified to a default value so that 0≦f(x)≦1 is true. Following modification at 918, or if x is not in the offset range at 916, operations proceed to 920, whereupon a value of the inflection point is generated.

The controller 108, the user device 114, or other processing component of the system 100 then scales the bulging and sagging curve portions of the tone reproduction curve based upon the inflection point value at 922. The inflection point is then scaled based on the curvature factor x at 924. The tone reproduction curve is applied to the received image data so as to generate contrast enhanced image data at 926. At 928, the enhanced image data is output the rendering engine of the document processing device 104 for output.

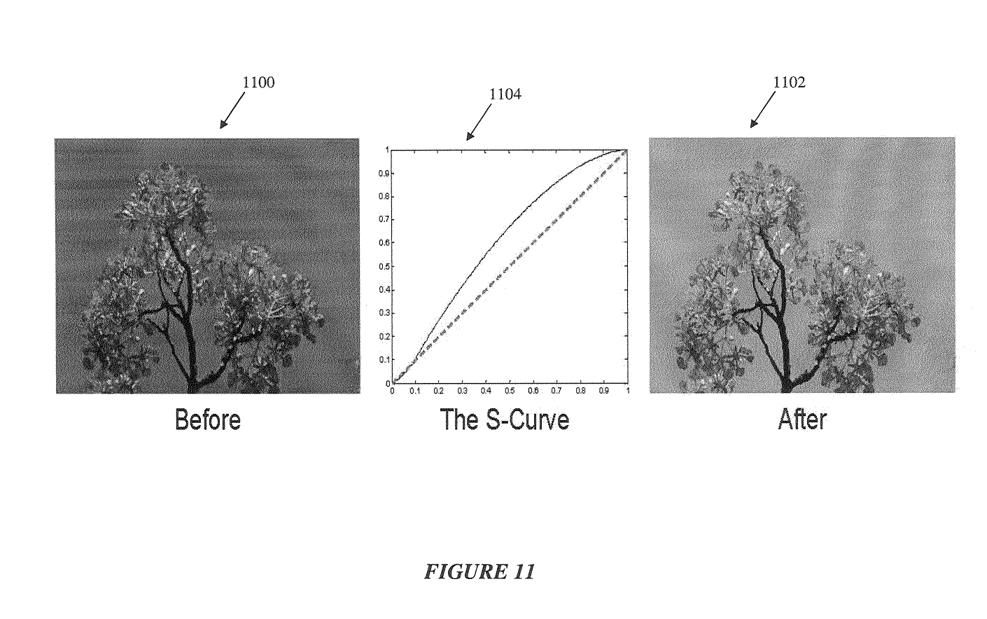

The preceding example methodologies will be better understood in conjunction with the illustrations of FIGS. 10-27 relating to image contrast enhancement. The system and method employs contrast enhancement of an input image by applying an S-shaped Tone Reproduction Curve (TRC) or “S-Curve”, to all of the pixel code values of the input image. FIG. 10 illustrates an S-Curve graph 1000 which shows the upper (bulging) part 1002 of the S-Curve makes the bright pixels brighter, while the lower (sagging) part 1004 of the S-Curve makes the dark pixels darker so as to increase the image contrast. The point at which upper part 1002 and lower part 1004 meet is called the Inflection Point 1006 as the curvatures of the upper part 1002 and the lower part 1004 change signs. FIG. 11 shows an input image 1100 and the result image 1102 via usage of the S-Curve 1104, defined as a generalized formulation of the S-Curve.

According to one embodiment of the subject application, image contrast is used hereinafter to describe the range of gray level variation within an image. For example, given an image of dimension M by N pixels:

I(m,n), 1<=m<=M and 1<=n<=N,

the image contrast is defined as the Standard Deviation from the Brightness Average B,

C=(Σm=1,M Σn=1, N(G(m,n)−B)2/N*M)1/2, where

B=(Σm=1,M Σn=1,N G(m,n))/(N*M) and G is the grayscale intensity of I.

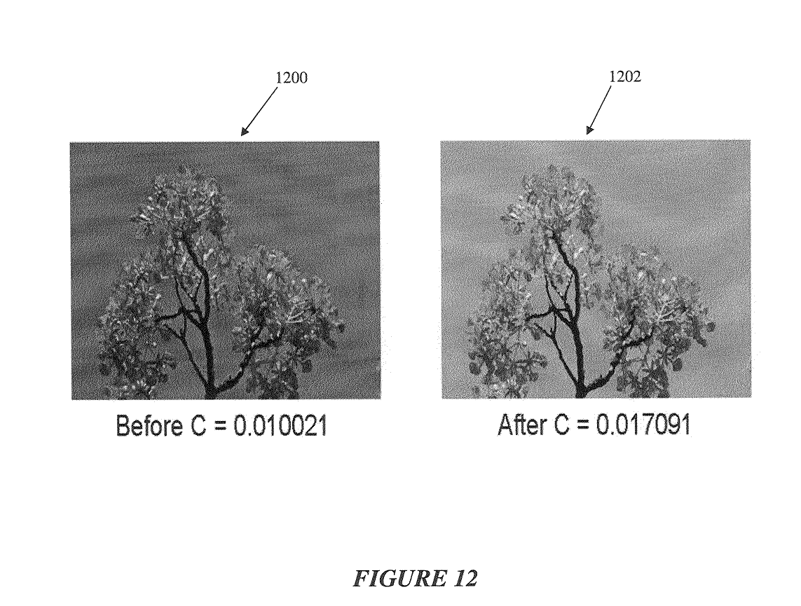

For purposes of explaining the example embodiments of FIGS. 10-27 only, the Contrast Measurement C is hereinafter defined as the Variance, C². FIG. 12 illustrates the Contrast Measurement before enhancement as the input image 1200 and after the contrast enhancement by the S-Curve as the output image 1202.

In accordance with one embodiment of the subject application, the sagging part of the S-Curve is suitably defined as a power-law mapping function, i.e.,

Output=Input^{γ}

where γ is the exponent that controls the curvature. The exponent γ is defined as a function of x, wherein x is the Curvature Factor, such that:

γ(x)=a+b*x+c*x²

where the coefficients a=0.01, b=−0.2, and c=8.0 are derived by regression.

Accordingly, solving the quadratic equation γ(x)=1 results in a determination that x=0.364503196008218 . . . , i.e. when x is close to 0.36450, the root of γ(x)−1, γ(x) is close to 1. As can be seen, when Output is close to Input, the mapping function is close to the identity. In the event that the Curvature Factor x is close to 0.3645, e.g. if |x−0.3645|<0.00001, then, for numerical stability, the mapping function is snapped to the identity. In the event that the Input is an array of evenly spaced numbers between 0 and 1 with step 0.01, i.e. in Matlab code:

Input=0:0.01:1;

Exponent=0.01−0.20*Factor+8*Factor̂2;

where Factor is the Curvature Factor, then the sagging part of the S-Curve:

Sagging=Input .̂ Exponent.

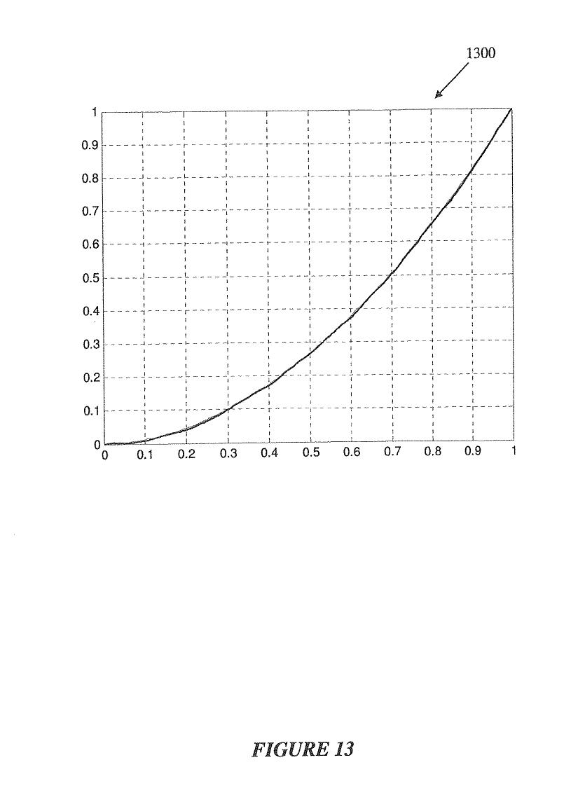

FIG. 13 illustrates the sagging part 1300 with a Curvature Factor=0.5.

The bulging part of the S-Curve may be defined as follows. First, an intermediate array Temp is constructed, preferably the same as the sagging part except enumerated backwards:

Temp=Sagging(100:−1:1)

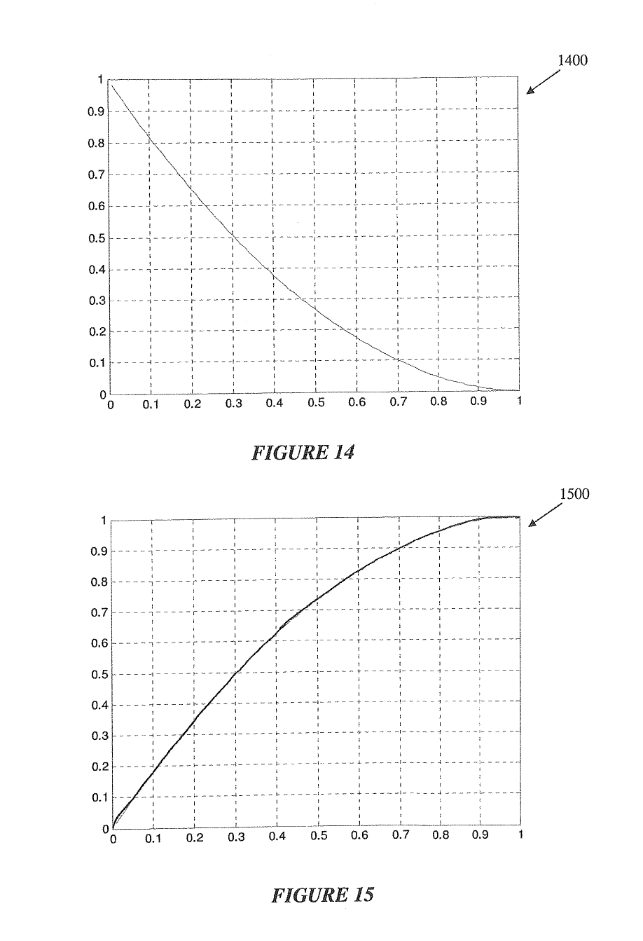

FIG. 14 shows such an array 1400. Next, a second intermediate array Temp2 is constructed as:

Temp2=1−Temp

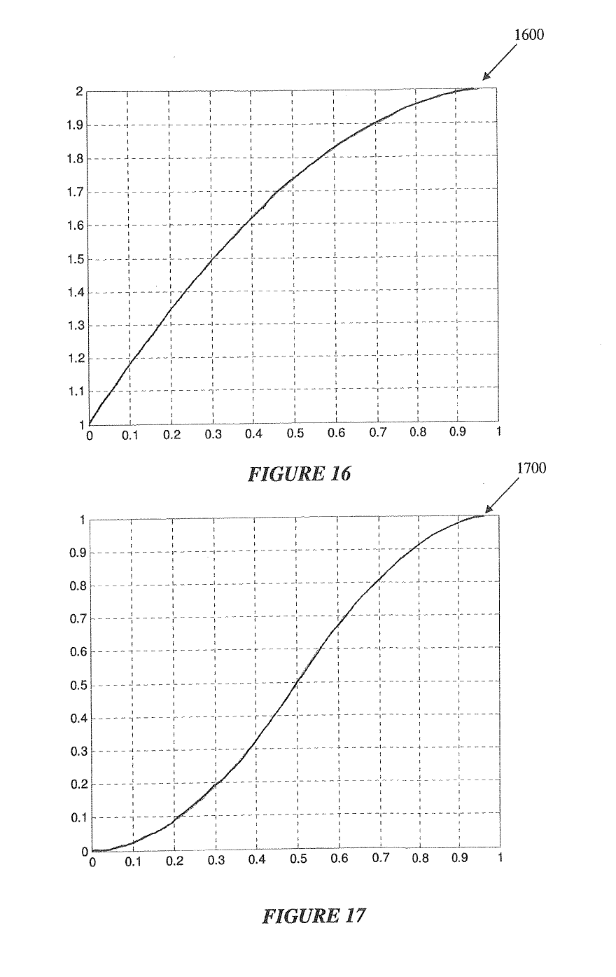

with FIG. 15 shows such an array 1500. Finally, the bulging part of the S-Curve is constructed as:

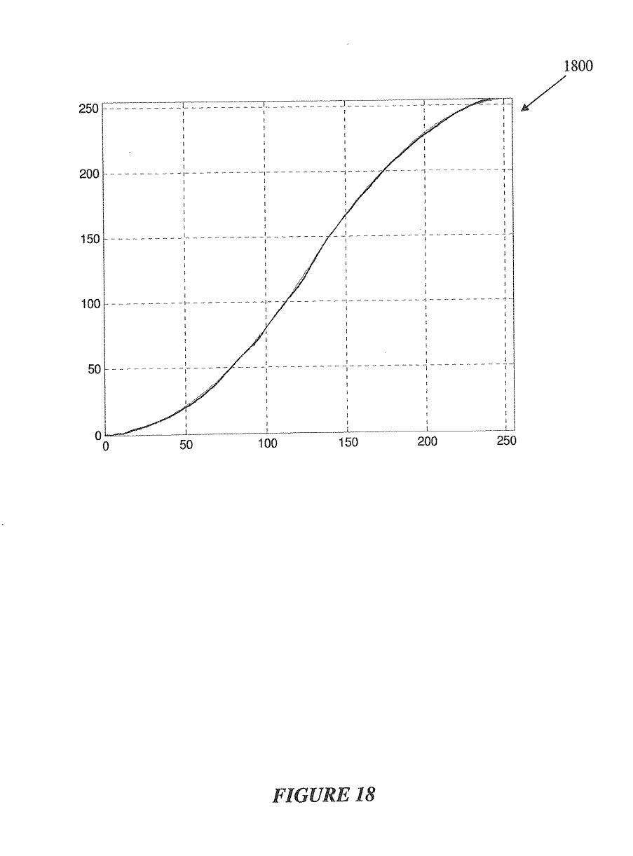

Bulging=1+Temp2

wherein, FIG. 16 depicts such an array 1600.

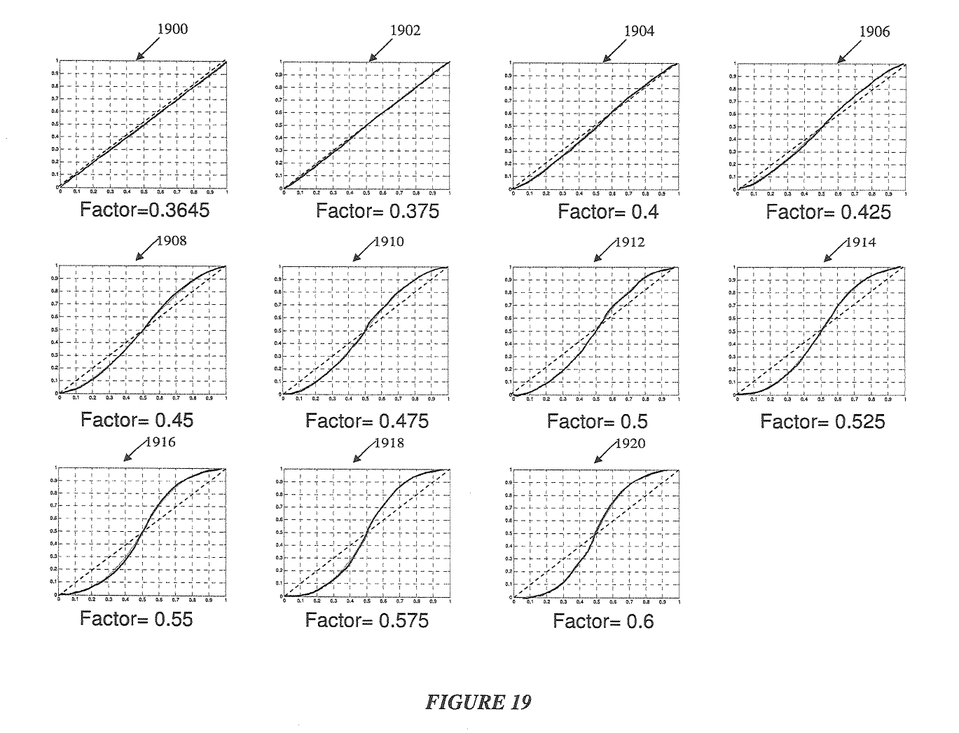

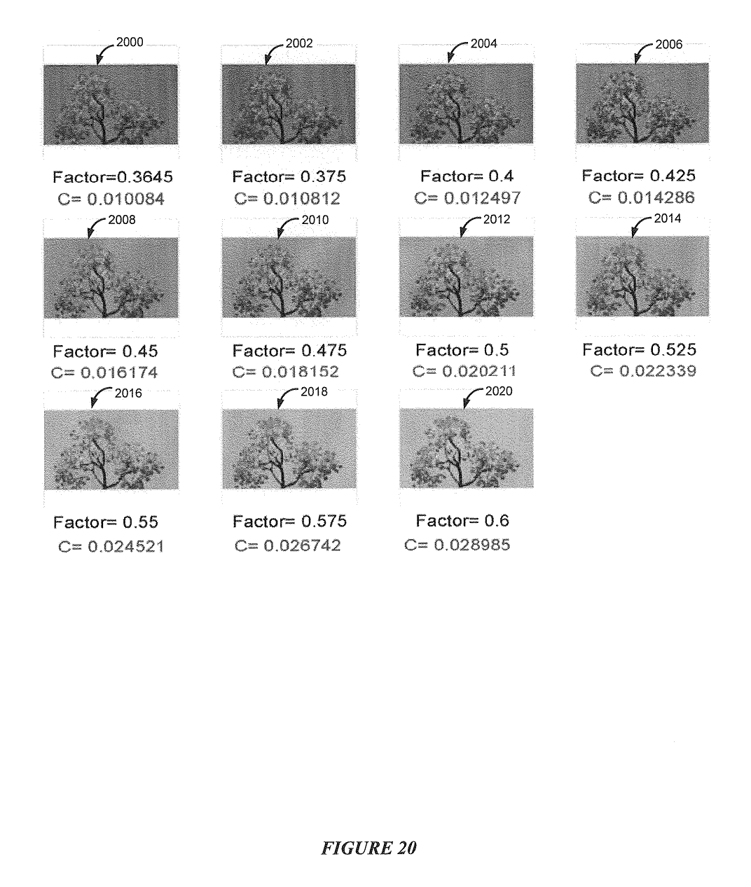

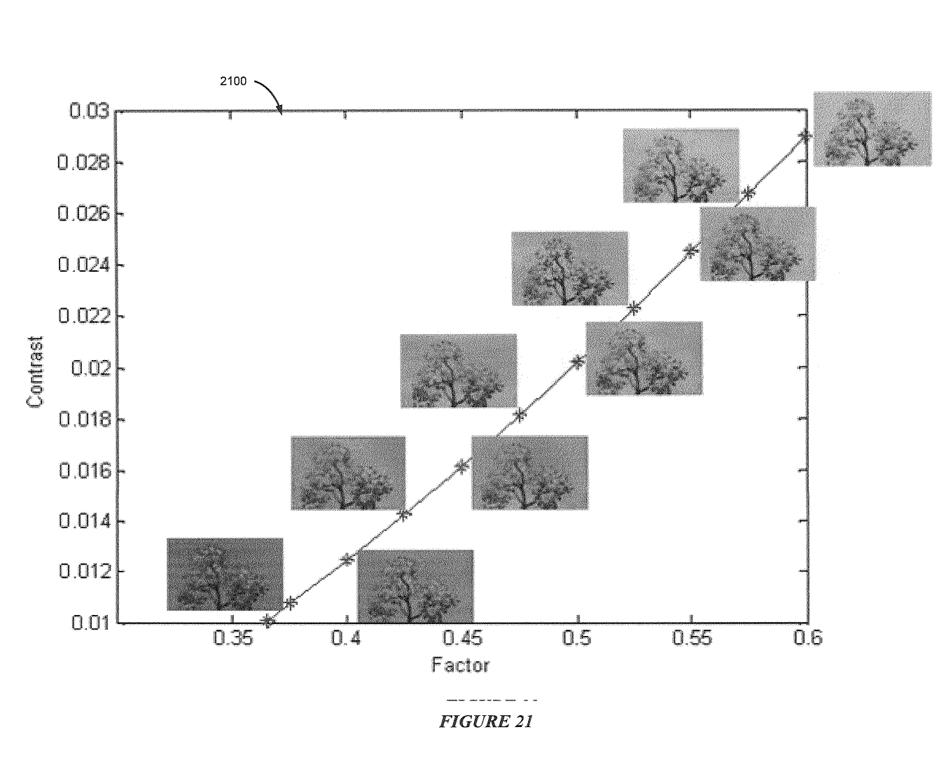

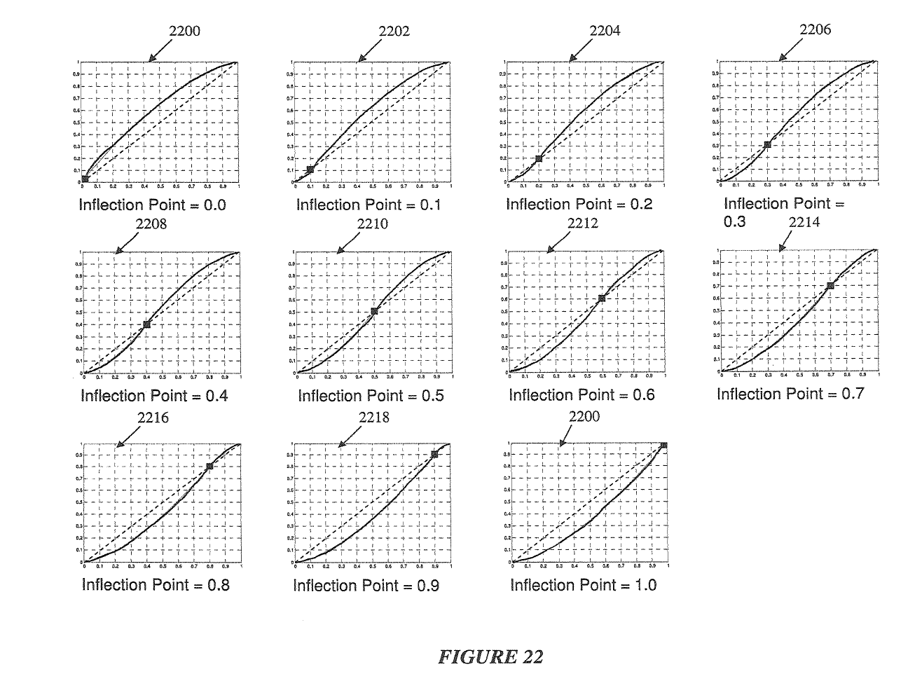

The S-Curve is thereafter defined by concatenating the array Sagging and the array Bulging, and normalizing both the input array and the output array to between 0 and 1. FIG. 17 illustrates such an S-Curve 1700 with Curvature Factor=0.5. The subject application enables the scaling of both the input array and the output array of the S-Curve to between 0 and 255 instead for the 8-bit code values, illustrated in the graph 1800 of FIG. 18, so as to facilitate the building of a lookup table for tone reproduction for all pixels in the input image. For purposes of illustrating the impact of the Curvature Factor value on the curvature of the S-Curve, FIG. 19 depicts several values (ranging from 0.3645 to 0.6) input for the Curvature Factor and the corresponding S-Curves 1900-1920 corresponding thereto. FIG. 20 shows the corresponding Contrast Measurements 2000-2020 associated with the Curvature Factors of FIG. 19, i.e., the larger the Curvature Factors (e.g. 0.6), the higher the Contrast Measurement (e.g. 0.028985). Continuing with the examples of FIGS. 19-20, FIG. 21 depicts the plot of Contrast Measurements against the Curvature Factors, which indicates that the Contrast Measurement increases in a substantially linear manner with respect to the Curvature Factor. The relationship between the Curvature Factor and the Contrast Measurement is direct, predictable, and intuitive.

After determining the Curvature Factor, the location of the Inflection Point is determined. The subject application provides the freedom to control the location of the Inflection Point for optimal Contrast Measurement. As discussed above, the S-Curve is defined as a concatenation of the Sagging array and the Bulging array, with the default location at the center, e.g. 0.5 between 0.0 and 1.0. Thus, given an Inflection Point (P), the Sagging array and the Bulging array must be scaled in accordance with P, both horizontally and vertically. Let

Scale1=P/0.5

then scaling the Sagging array vertically:

SaggingV=Sagging*Scale/2

and then horizontal scaling is suitably achieved via interpolation in the new domain:

SagginVH==interp1(Input, SaggingV,0:0.01/scale1:1)

Similarly, let

Scale2=(1−P)/0.5

and scale the Bulging array vertically:

BulgingV=Bulging*Scale2/2−(Scale2−1)

and then horizontally scale the array:

BulgingVH=interp1(1:100, BulgingV, 1:1/Scale2:100)

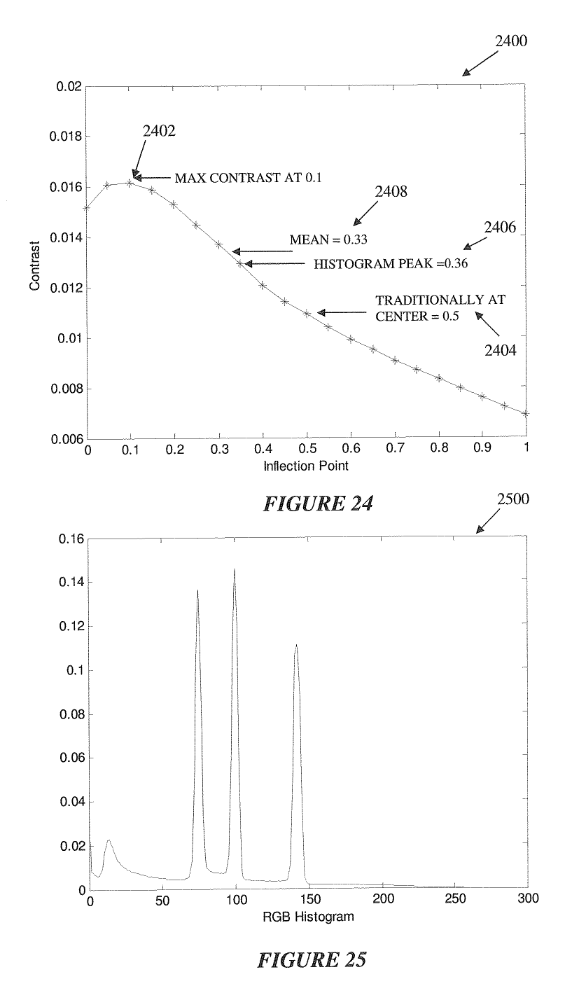

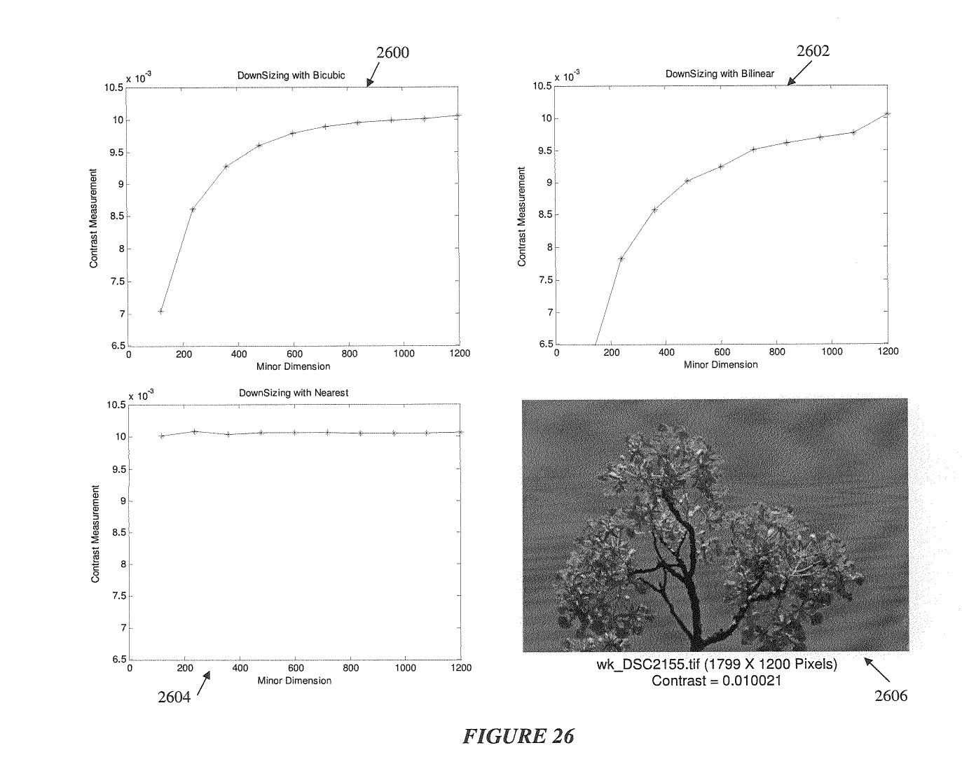

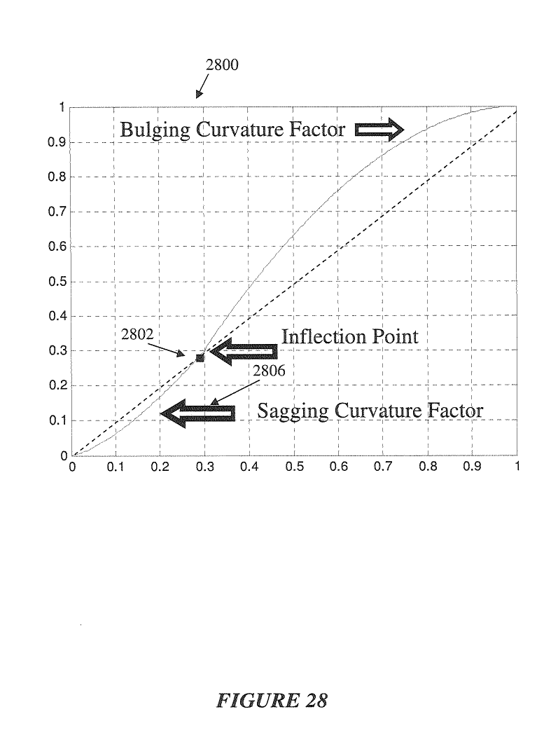

Thereafter, the S-Curve with a specification of the Inflection Point (P) is defined as the concatenation of the scaled arrays SagginVH and BulgingVH. The normalization to between 0 and 1 or between 0 and 255 depends on the application of the S-Curve. FIG. 22 illustrates a series of graphs 2200-2220 corresponding to FIGS. 19-21 which depict the variation of the Inflection Point (P) with a fixed Curvature factor. FIG. 23 shows the corresponding Contrast Measurement of the Inflection Points of the associated images 2300-2320. FIG. 24 shows the plot 2400 of Contrast Measurement vs. the Inflection Points while FIG. 25 shows the RGB histogram 2500 of the input image. The maximum Contrast Measurement occurs around 0.1 (referenced at 2402), not at the traditional location of the Inflection Point, i.e. at the center=0.5 (referenced at 2404), not at the peak of the RGB histogram (referenced at 2406), and not at the average (mean) of the histogram (referenced at 2408).

The methodology discussed herein enables the determination of the optimal location of the Inflection Point (P) with the maximum Contrast Measurement via an exhaustive search. For a fixed Curvature Factor, the exhaustive search facilitates locating the optimal location of the Inflection Point (P). However, the application of the S-Curve to the entire input image for each enumeration of the Inflection Point, e.g., P=0.0, P=0.1, . . . , P=0.9 and P=1.0, is time-consuming and resource intensive. Increasing the speed with which such location is determined is accomplished via the downsizing of the input image prior to application of the S-Curve. However, the Contrast Measurement deteriorates in a drastic manner if scaling methods are not selected. FIG. 26 illustrates several example scaling methodologies, i.e. bi-cubic 2600, bi-linear 2602, and nearest neighbor 2604. As demonstrated in FIG. 26, downsizing with sub-sampling (nearest neighbor method 2604) retains the Contrast Measurement down to, e.g. the minor dimension of the input image=500 pixels, as illustrated in the output image 2606.

The systems and methods of the subject application enable the fast location of the Inflection Point once the Curvature Factor is determined. Turning now to FIG. 27, a flowchart 2700 showing the search for the optimal location of the Inflection Point (P) methodology described in the aforementioned example embodiment of the subject application. Thus, at 2702, an input image M and a Curvature Factor F are received. At 2704, a determination is made whether the minor dimension of the input image M is greater than 500 pixels. If so, flow proceeds to 2706, whereupon the input image M is sub-sampled to sub-sampled image M′. If the minor dimension of the input image M is not greater than 500 pixels, flow proceeds to 2708, wherein the input image M is designated as M′.

After determining M′, flow progresses to 2710, whereupon C_{Max} is set equal to P_{Max}, which is set equal to P, which is set equal to 0.0 so as to initiate contrast measurement determination. At 2712, a determination is made whether the inflection point P is greater than 1.0. If so, flow proceeds to 2714 where P_{Max} is output as the inflection point. If the inflection point P is not greater than 1.0, flow progresses to 2716. At 2716, the S-Curve with Curvature Factor F, and the Inflection Point ranging from 0.0, 0.1, 0.2, . . . , 0.9, 1.0, are applied to the image M′. The Contrast Measurement C is then calculated from the resultant image at 2718. A determination is then made at 2720 whether the calculated C is greater than the determined C_{Max} of 2710. If C is greater than C_{Max}, flow proceeds to 724, where C_{Max} is output as equal to C and P_{Max} is output as the Inflection Point P. This output causes the Inflection Point P=P_{Max} to be selected such that P_{Max} has the highest Contrast Measurement. In the event that C is not greater than Cₘₐₓ, flow progresses to 2726, whereupon P is incremented by 0.1 and flow returns to 2712 as discussed above.

As previously addressed, the subject application adds further freedom so as to allow the S-Curve to have different curvatures for the Sagging part and the Bulging part in order to have separate considerations for preserving details in highlights verses shadows. In the event that the Curvature Factor of the Sagging array is Factor1 and the Curvature factor of the Bulging array is factor2, then the Sagging array may be defined as:

Input=0:0.01:1

Exponent1=0.01 −0.20*Factor1+8*Factor1̂2

Sagging=Input .̂ Exponent1

wherein the Bulging array is suitably defined as:

Exponent2=0.01−0.20*Factor2+8*Factor2̂2

Temp=Input .̂ Exponent2

Bulging=1+(1−Temp)

FIG. 28 illustrates a generalized formulation 2800 for an S-Curve having an Inflection Point=0.3 (at 2802), a Bulging Curvature Factor=0.5 (at 2804), and a Sagging Curvature Factor=0.43225 (at 2806).

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

While certain embodiments have been described, these embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

It is claimed:

1. Apparatus comprising a storage medium storing an image contrast enhancement program having instructions which when executed by a processor will cause the processor to enhance the contrast of images, the instructions of the image contrast enhancement program for:
generating a tone reproduction curve function for a plurality of pixel values, each including a brightness value, based on a contrast adjustment value, the brightness value of each of the pixels and a power-law function, the tone reproduction curve taking the form of an S-shaped curve including
a bulging curve portion corresponding to an area wherein a brightness of pixels having values representative of relative brightness is increased,
a sagging curve portion corresponding to an area wherein a brightness of pixels having values representative of relative darkness is decreased, and
an inflection point serving as a demarcation between the bulging area and the sagging area of the tone reproduction curve;
generating the exponent of the power-law function as a quadratic polynomial function f(x) in a range 0≦f(x)≦1, wherein x is defined as a curvature factor;
applying the tone reproduction curve to the image data to generate contrast enhanced image data;
outputting the contrast enhanced image data to an associated image rendering device.

2. The apparatus of claim 1 wherein:
the exponent of the power-law function is in the form: f(x)=a+bx+cx̂2;
a, b and c are constants; and
x is defined such that 0≧x≧root of f(x)−1, so as to generate the exponent as the quadratic polynomial function f(x) generally in a range 0≦f(x)≦1.

3. The apparatus of claim 2 wherein the instructions of the rendering program are further for comparing the value of x relative to a preselected offset range, and wherein, when the value of x is in the preselected offset range, the value of x is modified to a default value so as generate the quadratic polynomial function f(x) generally in a range 0≦f(x)≦1.

4. The apparatus of claim 2 wherein the preselected offset range is defined so as to generate the quadratic polynomial function f(x) such that it is equal to 1.

5. The apparatus of claim 1 wherein instructions of the rendering program are further for:
generating a value of the inflection point; and
scaling the bulging curve portion and the sagging curve portion in accordance with the value of the inflection point.

6. The apparatus of claim 5 wherein the instructions of the rendering program are further for scaling the inflection point value in accordance with the curvature factor x.

7. The apparatus of claim 5 wherein the value of the inflection point is generated by:
initializing a contrast maximum value, an inflection point maximum value and the value of the inflection point to 0;
determining whether the value of the inflection point is greater than 1 and, if not, calculating the contrast value of an image with an S-curve using the value of the inflection point;
setting the contrast maximum value to the contrast value and the inflection point maximum value to the value of the inflection point if the contrast is greater than the contrast maximum value;
incrementing the value of the inflection point;
repeating the determining and setting operations until the inflection point variable is greater than 1; and
setting the value of the inflection point at the inflection point maximum value.

8. An image contrast enhancement method comprising:
generating a tone reproduction curve function for a plurality of pixel values, each including a brightness value, based on a contrast adjustment value, the brightness value of each of the pixels and a power-law function, the tone reproduction curve taking the form of an S-shaped curve including
a bulging curve portion corresponding to an area wherein a brightness of pixels having values representative of relative brightness is increased,
a sagging curve portion corresponding to an area wherein a brightness of pixels having values representative of relative darkness is decreased, and
an inflection point serving as a demarcation between the bulging area and the sagging area of the tone reproduction curve;
generating the exponent of the power-law function as a quadratic polynomial function f(x) in a range 0≦f(x)≦1, wherein x is defined as a curvature factor;
applying the tone reproduction curve to the image data to generate contrast enhanced image data; and
outputting the contrast enhanced image data to an associated image rendering device.

9. The method of claim 8 wherein:
the exponent of the power-law function is in the form: f(x)=a+bx+cx̂2;
a, b and c are constants; and
x is defined such that 0≧x≧ root of f(x)−1, so as to generate the exponent as the quadratic polynomial function f(x) generally in a range 0≦f(x)≦1.

10. The method of claim 9 further comprising comparing the value of x relative to a preselected offset range, and wherein, when the value of x is in the preselected offset range, the value of x is modified to a default value so as to generate the quadratic polynomial function f(x) generally in a range 0≦f(x)≦1.

11. The method of claim 10 wherein the preselected offset range is defined so as to generate the quadratic polynomial function f(x) such that it is equal to 1.

12. The method of claim 8 further comprising:
generating a value of the inflection point;
scaling the bulging curve portion and the sagging curve portion in accordance with the value of the inflection point.

13. The method of claim 13 further comprising scaling of the inflection point value in accordance with the curvature factor x.

14. The method of claim 12 wherein the value of the inflection point is generated by:
initializing a contrast maximum value, an inflection point maximum value and the value of the inflection point to 0;
determining whether the value of the inflection point is greater than 1 and, if not, calculating the contrast value of an image with an S-curve using the value of the inflection point;
setting the contrast maximum value to the contrast value and the inflection point maximum value to the value of the inflection point if the contrast is greater than the contrast maximum value;
incrementing the value of the inflection point;
repeating the determining and setting operations until the inflection point variable is greater than 1; and
setting the value of the inflection point at the inflection point maximum value.

15. An image contrast enhancement system comprising:
means for generating a tone reproduction curve function, including at least one CPU and associated data storage, for a plurality of pixel values, each including a brightness value, based on a contrast adjustment value, the brightness value of each of the pixels and a power-law function, the tone reproduction curve taking the form of an S-shaped curve including
a bulging curve portion corresponding to an area wherein a brightness of pixels having values representative of relative brightness is increased,
a sagging curve portion corresponding to an area wherein a brightness of pixels having values representative of relative darkness is decreased, and
an inflection point serving as a demarcation between the bulging area and the sagging area of the tone reproduction curve;
means for generating the exponent of the power-law function as a quadratic polynomial function f(x) in a range 0≦f(x)≦1, wherein x is defined as a curvature factor;
means for applying the tone reproduction curve to the image data to generate contrast enhanced image data; and
means for outputting the contrast enhanced image data to an associated image rendering device.

16. The system of claim 15 wherein:
the exponent of the power-law function is in the form: f(x)=a+bx+cx̂2;
a, b and c are constants; and
x is defined such that 0≧x≧root of f(x)−1, so as to generate the exponent as the quadratic polynomial function f(x) generally in a range 0≦f(x)≦1.

17. The system of claim 16 further comprising means for comparing the value of x relative to a preselected offset range, and wherein, when the value of x is in the preselected offset range, the value of x is modified to a default value so as to generate the quadratic polynomial function f(x) generally in a range 0≦f(x)≦1.

18. The system of claim 17 wherein the preselected offset range is defined so as to generate the quadratic polynomial function f(x) such that it is equal to 1.

19. The system of claim 15 further comprising:
means for generating a value of the inflection point;
means for scaling the bulging curve portion and the sagging curve portion in accordance with the value of the inflection point.

20. The system of claim 19 further comprising means for scaling of the inflection point value in accordance with the curvature factor x.
